(19) United States
(12) Patent Application Publication
(10) Pub. No.: US 2003/0081888 A1
(43) Pub. Date: May 1, 2003

(54) Integrated wavelength router

(76) Inventor: Christopher Richard Doerr, Middletown, NJ (US)

Correspondence Address: Docket Administrator, (Room 3J-219), Lucent Technologies Inc., 101 Crawfords Corner Road, Holmdel, NJ, 07733-3030, US

(21) Appl. No.: 10/035,628

(22) Filed: Nov. 1, 2001

(51) Int. Cl. G02B 6/293; G02B 6/26; G02B 6/35

(52) U.S. Cl. 385/24; 385/15; 385/16

(57) ABSTRACT

A router comprises a demultiplexer arranged to receive an input WDM signal containing N wavelengths, and apply its output, namely, the N separated the wavelengths, to a binary tree containing log₂K stages of interconnected 1×2 switches. The switches can be integrated, and have their outputs crossing each other at each stage. The outputs of the final stage are applied to, and combined in, K multiplexers, which provide the K outputs of the router. If desired, a set of shutters can be interposed in the waveguides leading to the muliplexer inputs, thereby providing additional isolation.

### TECHNICAL FIELD

The present invention relates generally to optical communications, and more particularly to an integrated wavelength router that can be used in a wavelength division multiplexed (WDM) optical communication system as a 1×K wavelength-selective cross connect (WSC), where K is an integer representing the number of output paths.

### BACKGROUND OF THE INVENTION

At nodes in a wavelength-division multiplexed (WDM) network, it is often necessary to route each wavelength channel from a single incoming fiber independently to one of a plurality of output paths. Some of these paths may terminate immediately into a receiver, and some may continue through a network. Such a wavelength routing device can be called a 1×K wavelength-selective cross connect (WSC), where K is the number of output paths.

One approach to designing a WSC is the double-binary-tree spatial cross connect, shown in FIG. 1. An input port 100 receives a WDM optical signal illustratively containing four channels with wavelengths λ₁ to λ₄. The wavelengths are separated in a demultiplexer 101 and routed to individual 1×2 switches 103-1 to 103-4 that form a first binary tree level. The outputs from each of the switches 103-1 to 103-4 can be directed to one of two 1×2 switches in a second binary tree level containing eight switches 105-1 to 105-8. Thus, for example, wavelength λ₁ can exit switch 103-1 and be routed to switch 105-1 or to switch 105-5, wavelength λ₂ can exit switch 103-2 and be routed to switch 105-2 or to switch 105-6, and so on. The switches in the first and second binary tree levels can be thought of as forming the first part of the double-binary tree.

Still referring to FIG. 1, the output side of the WSC contains the second part of the double-binary tree. Specifically, the outputs from each of the switches 105-1 to 105-8 can each be directed to one of two switches in a third binary tree level containing eight individual 2×1 switches 107-1 to 107-8. Conversely, each of the switches 107-1 to 107-8 receives inputs from two of the switches in the second binary tree level, and passes one of those inputs to a fourth binary tree level containing four individual 2×1 switches 109-1 to 109-4. Each of these switches likewise receives inputs from two of the switches in the third binary tree level, and passes one of those inputs to its output line. The outputs of the arrangement are thus available on output lines 110-1 through 110-4.

The arrangement of FIG. 1 is somewhat complicated and, because of this, is not easily fabricated in a small area. It also requires many switches, potentially requiring a high electrical power consumption. Furthermore, it has limited functionality, in that only one wavelength channel can appear at each output port, whereas it is desired that many, or all the, wavelength channels can be multiplexed together into each output port. Furthermore, in the arrangement of FIG. 1, the waveguide crossings must be at large angles, because there is no filtering of crosstalk from the crossings, resulting in an undersirably large layout.

Another prior art arrangement, namely a 2×2 WSC described in K. Okamoto, M. Okuno, A. Himeno, and Y. Ohmori, “16-channel optical add/drop multiplexer consisting of arrayed-waveguide gratings and double-gate switches,” Electron. Lett., vol. 32, pp. 1471-1472, 1996, is illustrated in FIG. 2. This arrangement has 2 input ports 200-1 and 200-2, each of which is arranged to supply an input WDM signal to a respective demultiplexer 201-1 and 201-2. Assuming that the input WDM signals applied to input ports 200-1 and 200-2 each contain four channels with wavelengths λ₁ to λ₄, these wavelengths are separated in demultiplexers 201-1 and 201-2, and applied to inputs of a first (level) set of eight 1×2 switches 203-1 to 203-8. The outputs of each of the switches 203-1 to 203-8 are applied to two different switches in a second (level) set of eight 2×1 switches 205-1 to 205-8. Finally, the outputs of switches 205-1 to 205-8 are applied to one of the two multiplexers 215-1 and 215-2, such that each multiplexer can combine four wavelengths onto the two output lines 210-1 and 210-2.

The arrangement in FIG. 2 is limiting, in that it again is not easy to fabricate in a compact device. Also, it is not clear how to expand the design to a case of more than 2 outputs.

### SUMMARY OF THE INVENTION

A router arranged in accordance with the present invention comprises a demultiplexer arranged to receive an input WDM signal containing multiple wavelengths, and apply its output, namely, the separated the wavelengths, to a binary tree, i.e., at least two stages, of interconnected 1×2 switches. The switches are integrated, and have their outputs crossing each other at each stage. The outputs of the switches in the final stage are applied to, and combined in, K multiplexers, which provide the outputs of the router. If desired, a set of shutters can be interposed in the waveguides leading to the multiplexer inputs, thereby providing additional isolation. Advantageously, the wavelength router of the present invention can be made in a compact, integrated fashion with high performance and low complexity.

### BRIEF DESCRIPTION OF THE DRAWINGS

The present invention will be more fully appreciated by consideration of the following detailed description, which should be read in light of the drawing in which:

FIG. 1 is a block diagram of a prior art double-binary-tree wavelength-selective spatial cross connect (WSC);

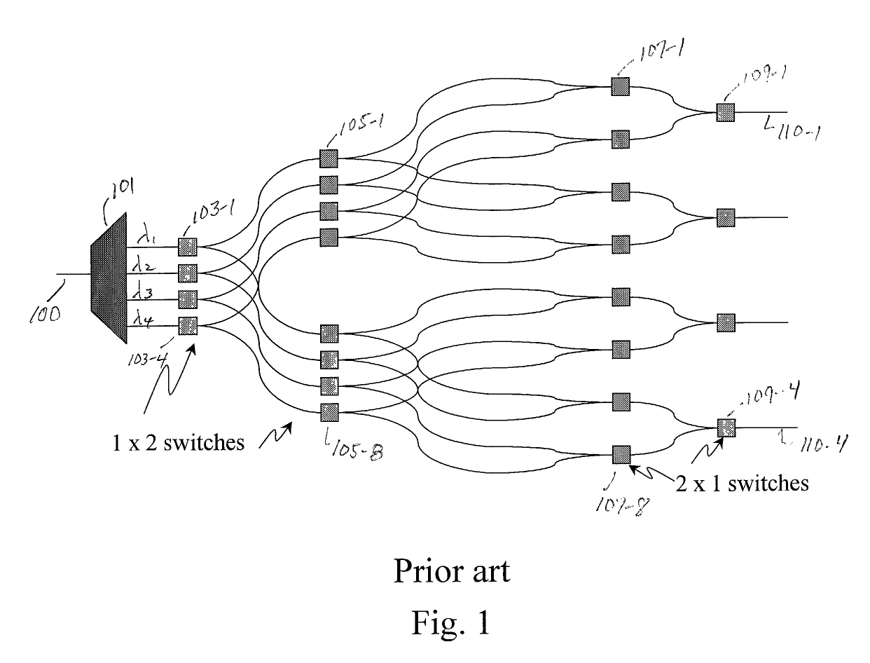

FIG. 2 is a block diagram of a prior art 2×2;

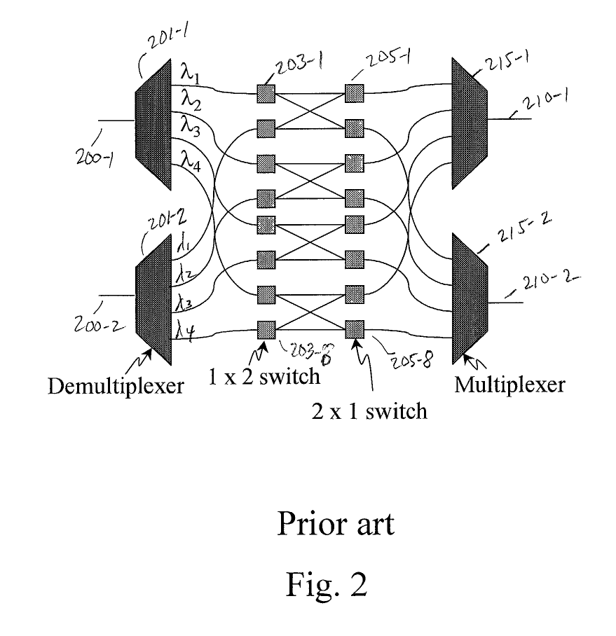

FIG. 3 is a block diagram of one embodiment of a wavelength router arranged in accordance with the present invention;

FIG. 4 is a diagram illustrating the component arrangement (layout), as laid out in integrated silica waveguides, of a router of the type shown in FIG. 3; and

FIG. 5 is a block diagram of another embodiment of a wavelength router arranged in accordance with the present invention.

### DETAILED DESCRIPTION

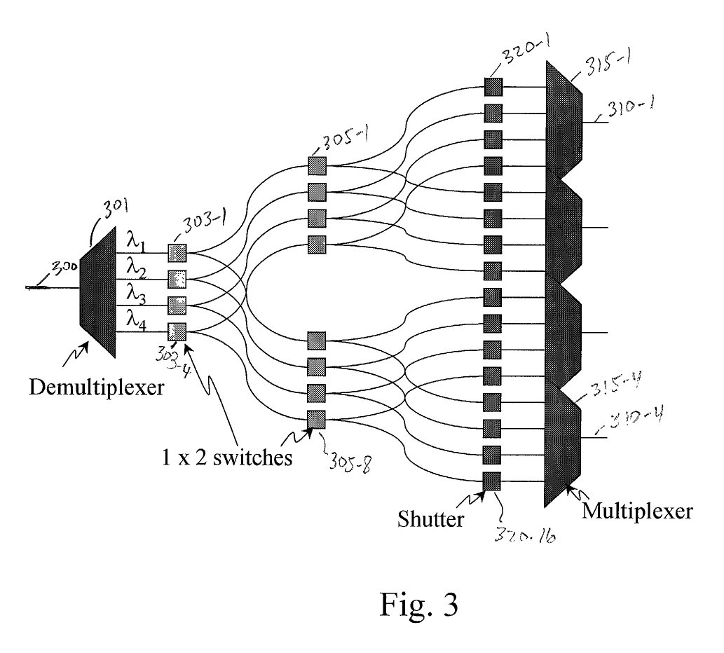

Referring now to FIG. 3, there is shown a block diagram of one embodiment of a wavelength router arranged in accordance with the present invention. A demultiplexer 301 receives a multi-channel WDM input signal illustratively containing N=4 wavelengths λ₁ to λ₄, on input 300, and applies each wavelength channel via one of its N outputs to (a) a binary tree containing log₂K (or the next higher integer number of) stages of 1×2 switches with their outputs crossing each other at each stage, and thence to (b) a set of K multiplexers, each of which have N inputs, and which combine outputs from N switches in the final stage to form K output ports of the router. The switches (and the optional shutters described below) can be Mach-Zehnder interferometers and can be activated thermooptically

FIG. 3 shows the case of N=4 and K=4. Specifically, the four wavelength channels applied to demultiplexer 301 via input 300 are separated and applied to respective inputs of each of the four 1×2 switches 303-1 to 303-4 in the first stage. Each of the outputs of switches 303-1 to 303-4 are applied to inputs of two of the eight switches 305-1 to 305-8 in the second stage, such that switches 305-1 to 305-4 receive all four wavelengths, as do switches 305-5 to 305-8. The outputs of switches 305-1 to 305-8 in the second (final) stage are applied to inputs of two of the K=4 multiplexers 315-1 to 315-4, such that each of the multiplexers receives N=4 inputs, either one from each of the switches 305-1 to 305-4, or one from each of the switches 305-5 to 305-8. In this manner, each of the wavelengths is available at each of the multiplexers and thus at each of the K=4 router outputs 310-1 to 310-4.

If desired, as shown in FIG. 3, K×N=16 shutters (on-off switches) 320-1 to 320-16 can be interposed in each of the N×4 inputs to each the K=4 multiplexers. The shutters serve to dilate the switch fabric, ensuring that every undesired path through the switch encounters at least two closed switches/shutters, improving the crosstalk. K of the NK shutters are open at all times. If the 1×2 switches have very high extinction ratios, one could eliminate the shutters.

The router operates as follows: suppose one wishes to send λ₁, where λᵢ is the wavelength of channel i, to port 310-1 and λ₂ to port 310-4. Then for λ₁, all the switches in its binary tree are set to the “up” position, and shutter 320-1 for λ₁ is open, with all the other λ₁ shutters 320-5, 320-9 and 320-13 closed. For λ₂, all the switches in its binary tree are set to the “down” position, and shutter 320-16 for λ₂ is open, with all the other λ₂ shutters 320-12, 320-8 and 320-4 closed.

Having the binary trees cross at each stage minimizes the number of waveguide crossings. See, for example, T. Murphy, S.-Y. Suh, B. Commissiong, A. Chen, R. Irvin, R. Grencavich, and G. Richards, “A strictly non-blocking 16×16 electrooptic photonic switch module,” ECOC 2000, paper 11.2.2, 4 93-94 (2000). Also, this architecture has the advantage that crosstalk that occurs in the waveguide crossings is filter out by the multiplexers, and thus one can use small angles for the crossings, making the layout compact.

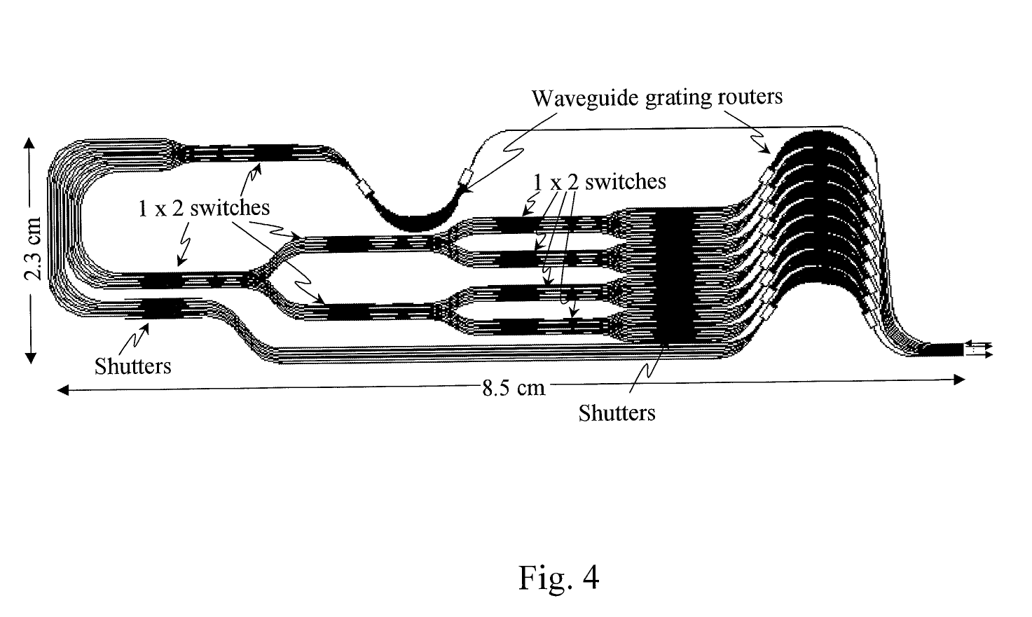

As shown in FIG. 4, the entire circuit of FIG. 3 can be integrated into a compact planar arrangement for fitting three such circuits on a 5-inch wafer in which N=8 and K=9, and in which the demultiplexers and multiplexers are waveguide grating routers (WGR's) formed on one or more silica or silicon substrates. The WGR's can be of the type described in C. Dragone, “An N×N optical multiplexer using a planar arrangement of two star couplers,” IEEE Photon. Technol. Lett., vol. 3, pp. 812-815, 1991. The switches and shutters can be Mach-Zehnder interferometers (MZI's). Note that if K is not a power of two, some branches are terminated early, as is the first branch in FIG. 4.

As one can see, the WGR's can be stacked, making the design highly compact. The design in FIG. 4 is laid out to be in silica waveguides with an index step of 0.80%. The switch and shutter MZI's contain thermooptic phase shifters, which switch by heating the waveguide below with an electric current. Each shutter consists of two y-branch waveguides, with a path-length difference between them equal to λ/2, such that they are opaque when no thermooptic power is applied. Each 1×2 switch consists of a y-branch and a multiple-section 50/50 coupler that gives high fabrication and polarization tolerance.

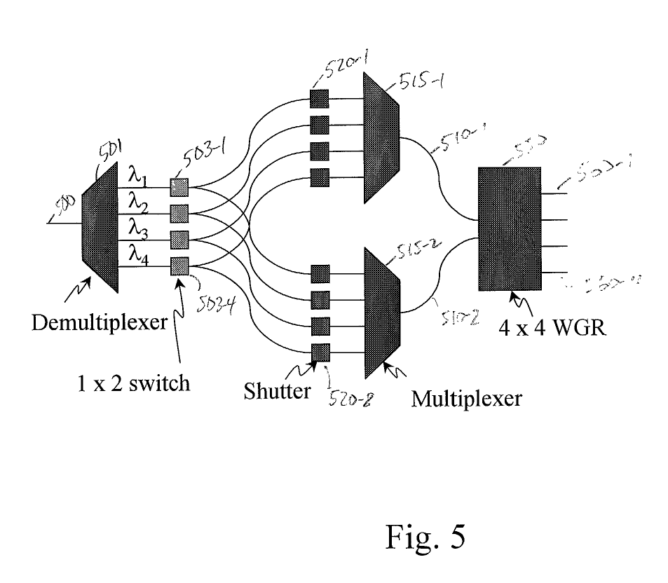

If one wishes to have N outputs in the case where N>K, one can connect the K outputs of the above-described architecture to an N×N WGR. Thus, as shown in FIG. 5, for the case where N=4 and K=2, the 4 wavelength channel outputs from demultiplexer 501 are applied to four 1×2 switches 503-1 to 503-4, the outputs of which are connected to each of two multiplexers 515-1 and 515-2 via individual shutters 520-1 to 520-8. The outputs 510-1 and 510-2 of multiplexers 515-1 and 515-2 are connected as inputs to a 4×4 WGR 550, such that output lines 560-1 to 560-4 can receive all 4 wavelengths, but with a limited choice of wavelength ordering among the 4 outputs. This arrangement has less flexibility than a full 1×N switch, but also has fewer switches.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims. For example, it should be noted that the proposed device can be used also as a K×1 switch, simply by turning the input into an output and the outputs into inputs.

We claim:

1. An integrated wavelength router comprising
a demultiplexer arranged to couple individual wavelengths in an input optical WDM signal to N respective demultiplexer outputs,
a binary tree including at least first and second stages of interconnected 1×2 switches, each of the switches in said first stage arranged to couple one of said N outputs of said demultiplexer to inputs of at least two switches in said second stage, and
a plurality of K multiplexers arranged to combine the outputs from a plurality of switches in said second stage to form K outputs of said router.

2. The invention defined in claim 1 wherein the outputs of each switch are waveguides crossing each other to form inputs to the switches in the next stage.

3. The apparatus of claim 1 wherein said demultiplexer, said binary tree, and said multiplexers are all formed in a planar arrangement on one or more substrates.

4. The apparatus of claim 3 wherein the demultiplexer and said multiplexers are waveguide grating routers.

5. The apparatus of claim 3 wherein said switches are Mach-Zehnder interferometers.

6. The apparatus of claim 5 wherein said switches are activated thermooptically.

7. The apparatus of claim 1 in which the outputs of said multiplexers are connected to an N×N waveguide grating router.

8. The invention defined in claim 1 further including a plurality of shutters disposed before the inputs of said multiplexers.

9. An integrated wavelength router comprising
a binary tree comprising at least first and second stages of interconnected 1×2 switches,
a demultiplexer arranged to couple N individual wavelengths in a WDM optical signal to inputs of respective switches in said first stage, and
a plurality of K multiplexers arranged to combine outputs from a plurality of switches in said second stage to form outputs of said router.

10. A router comprising
a binary tree containing log₂K stages of interconnected 1×2 switches,
a demultiplexer arranged to receive an input WDM signal containing N wavelengths, and apply N separated wavelengths to inputs of switches in a first of said log₂K switch stages, and
K multiplexers arranged to combine outputs from switches in the last of said log₂K switch stages to form K outputs of said router.

11. The router of claim 10 wherein said switches are integrated in a planar arrangement on one or more silica substrates, and wherein the outputs of the switches in each of said stages cross each other before being connected to inputs of the switches in the next stage.

12. The router of claim 10 further including a plurality of shutters interposed in the paths leading to the inputs of said multiplexers.

13. The invention defined in claim 10 wherein the outputs of each switch are waveguides crossing each other to form inputs to the switches in the next stage.

14. The apparatus of claim 10 wherein said demultiplexer, said switches and said multiplexers are all formed in a planar arrangement on one or more substrates.

15. The apparatus of claim 14 wherein the demultiplexer and said multiplexers are waveguide grating routers.

16. The apparatus of claim 14 wherein said switches are Mach-Zehnder interferometers.

17. The apparatus of claim 16 wherein said switches are activated thermooptically.

18. The apparatus of claim 10 in which the outputs of said multiplexers are connected to an N×N waveguide grating router.
